(19) United States
(12) Patent Application Publication
(10) Pub. No.: US 2019/0291936 A1
(43) Pub. Date: Sep. 26, 2019

(54) Inflation-Free Double-Sided Airbag and Preparation Method Thereof

(71) Applicant: Dongguan Zhongding Plastic Production Co., Ltd., Dongguan (CN)

(72) Inventor: Bronte Liu, Dongguan (CN)

(21) Appl. No.: 16/166,700

(22) Filed: Oct. 22, 2018

(30) Foreign Application Priority Data
Mar. 21, 2018 (CN) 201810235314.8

(51) Int. Cl. B65D 81/03; B65D 81/05; B29C 65/02; B29C 65/00

(52) U.S. Cl. CPC B65D 81/03; B65D 81/052; B29C 65/02; B65D 2581/055; B29C 66/91951; B29C 66/929; B29C 66/71

(57) ABSTRACT

Disclosed are an inflation-free double-sided airbag and its preparation method. The inflation-free double-sided airbag includes upper airbags arranged into an array and connected to one another to form a planar body, lower airbags arranged into an array and connected to one another to form a planar body, an elastic layer disposed between the upper airbag and the lower airbag and having an upper surface connected to the upper airbag and a lower surface connected to the lower airbag, and a soft edge connecting portion disposed between two adjacent upper airbags and between two adjacent lower airbags. After the airbag is pierced, it still has the protection effect. When an external pressure is exerted onto the inflation-free double-sided airbag, the elastic material layer provides a buffering effect to minimize the degree of deformation of the airbags and reduce impacts on a user or a product.

### FIELD OF THE INVENTION

The present invention relates to the technical field of airbags, and more particularly to an inflation-free double-sided airbag and its preparation method,

### BACKGROUND OF THE INVENTION

In general, a product storage and transportation protective gear requires an airbag, an air cushion or a filling, but a conventional airbag has a plurality of bags arranged into an array and connected to form a plane, so that the impact resistance of the airbag is poor. Once the airbag breaks, the product may be damaged and people may be injured easily. Therefore, a packaging cushion as disclosed in Pat. No. 201410358056.4 includes a latitudinal airbag and a longitudinal airbag to improve the pressure resistance, but a ventilation duct is disposed between two adjacent airbags, so that once if one of the airbags is pierced or broken, the elasticity of the other airbags will be affected, and the safety cannot be guaranteed.

### SUMMARY OF THE INVENTION

In view of the aforementioned drawbacks, the inventor of the present invention based on years of experience in the related industry to conduct extensive research and experiment, and finally developed an inflation-free double-sided airbag with good impact resistance and good protection effect to users and products and its preparation method with simple and easy processes, high efficiency, low production cost and high consistency to overcome the drawbacks of the prior art.

Therefore, it is a primary objective of the present invention to provide an inflation-free double-sided airbag comprising a plurality of upper airbags arranged into an array and coupled to one another to form a planar body; a plurality of lower airbags arranged into an array and coupled to one another; and an elastic material layer, disposed between the upper airbag and the lower airbag, and the upper surface of the elastic material layer being coupled to the upper airbag, and the lower surface of the elastic material layer being coupled to the lower airbag, and a soft edge connecting portion formed between two adjacent upper airbags and between two adjacent lower airbags.

With the elastic material layer designed between the upper airbag and the lower airbag, the present invention still can protect users or products even after the upper airbag or the lower airbag is pierced. On the other hand, the elastic material layer provides a buffering effect to reduce the degree of deformation of the upper airbags and the lower airbags when an external pressure is exerted onto the upper airbags or the lower airbags, so as to minimize the impact exerted onto the user or product effectively.

Further, the upper airbag and the lower airbag are installed symmetrically with respect to the elastic material layer.

With the symmetrical arrangement of the upper airbag and the lower airbag, the present invention keeps the upper airbag to be attached to the lower airbag closely to provide a better reliability.

Further, the upper airbag and the lower airbag are staggered along the elastic material layer.

With the staggered arrangement of the upper airbag and the lower airbag, the present invention provides a larger protection area for the user or product, so as to achieve an all-around protection.

Further, the upper surface of the upper airbag and the lower surface of the lower airbag are substantially arc shaped.

With a half-arc shaped cross-section of the upper airbag and the lower airbag, the inflation-free double-sided airbag of the present invention has a round edge and provides a more comfortable touch to users and a better protection to the products.

Further, the elastic material layer is a TPU layer, a TPE layer, or a PVC layer.

The elastic material layer of the present invention is one selected from the TPU layer with the features of high elasticity, easily accessible material, and low cost.

Further, the elastic material layer has a thickness of 0.3˜1.0 mm.

The elastic material layer of the present invention having a thickness of 0.3˜1.0 mm provides a good buffering effect and further guarantees a good connection between the upper airbag and the lower airbag.

Further, the width of the soft edge connecting portion to the width of the upper airbag are in the ratio of 1:1˜5, and the width of the soft edge connecting portion and the width of the lower airbag are in the ratio of 1:1˜5.

With the ratio of the width of the soft edge connecting portion to the width of the upper airbag and the lower airbag equal to 1:1˜5, the upper airbag and lower airbag can be connected closely with the elastic material layer to provide a better protection effect and a more reliable use.

The preparation method of the inflation-free double-sided airbag comprises the following two steps. Step (1) Unilateral Molding: Prepare a flat thermoplastic material. Heat the flat thermoplastic material to 120˜180° C. and then press the flat thermoplastic material by a pressure of 5 kg/cm²-10 kg/cm² to form separated grooves. Cool the flat thermoplastic material to room temperature to obtain a single-sided airbag material. (2) Sealing: Prepare two pieces of the molded single-sided airbag materials. Place the elastic material layer between the two pieces of airbag materials. Heat the elastic material layer to 120˜180° C. and then press the elastic material layer and the two pieces of airbag materials by a pressure of 10 kg/cm²-20 kg/cm², and naturally cool them to room temperature for formation.

The preparation method of the present invention has the features of simple process, easy operation, and high production efficiency, and the manufactured inflation-free double-sided airbag has the features of compact structure and long service life.

Wherein, the heating rate of heating the flat thermoplastic material to 120˜180° C. as described in Step (1) is 5-15° C./min.

With the heating rate of 5-15° C./min, the whole flat thermoplastic material can be heated uniformly, so that the flat thermoplastic material can be stretched uniformly under pressure, and the manufactured single-sided airbags of the present invention has a better uniformity.

Wherein, the cooling rate as described in Step (1) is 35˜50° C./min.

With the cooling rate of 35˜50° C./min in Step (1), the single-sided airbag of the present invention can be molded better.

Wherein, the heating rate of heating the elastic material layer to 120˜180° C. as described in Step (2) is 20-35° C./min.

With the heating rate of 20˜35° C./min as described in the Step (2), the present invention provides a fast lamination rate and a high production efficiency.

In summation, the present invention has the following beneficial effects. The present invention has the elastic material layer disposed between the upper airbag and the lower airbag, so that if the upper airbag or the lower airbag is pierced, the invention still can protect users or product. On the other hand, the elastic material layer provides a buffering effect to reduce the degree of deformation of the upper airbags and the lower airbags when an external pressure is exerted onto the upper airbags or the lower airbags, so as to minimize the impact exerted onto the user or product effectively. In addition, the preparation method of the present invention has the features of simple process, easy operation, and high production efficiency, and the manufactured inflation-free double-sided airbag of the invention has the features of compact structure and long service life.

### BRIEF DESCRIPTION OF THE DRAWINGS

FIG. 1 is a cross-sectional view of a structure of the present invention; and

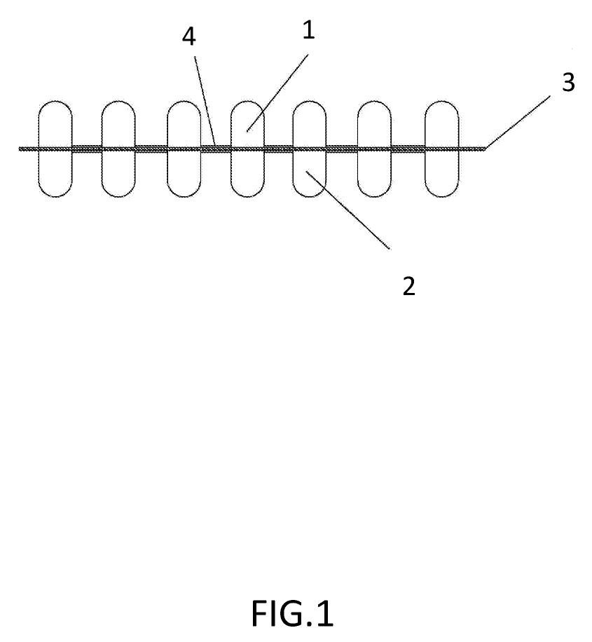

FIG. 2 is a cross-sectional view of another structure of the present invention.

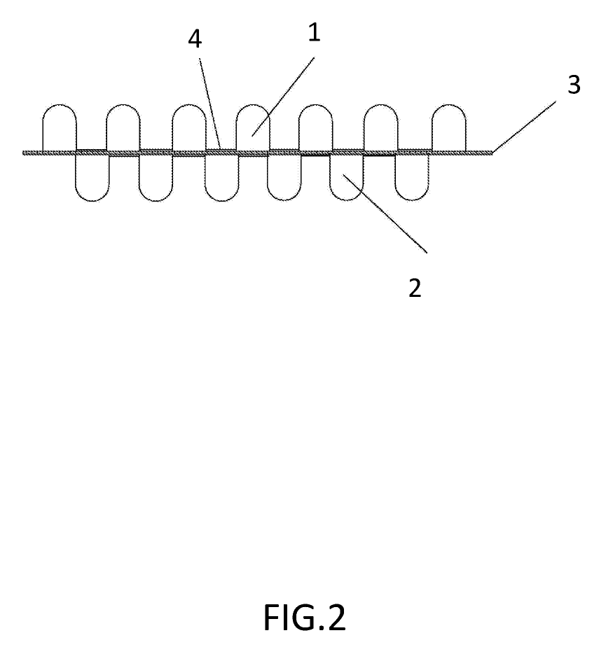

### DESCRIPTION OF THE PREFERRED EMBODIMENTS

The technical contents of the present invention will become apparent with the detailed description of preferred embodiments accompanied with the illustration of related drawings as follows. It is intended that the embodiments and figures disclosed herein are to be considered illustrative rather than restrictive.

### Embodiment 1

An inflation-free double-sided airbag comprises a plurality of upper airbags 1 arranged into an array and coupled to one another to form a planar body, a plurality of lower airbags 2 arranged into an array and coupled to one another to form a planar body, an elastic material layer 3 coupled between the upper airbag 1 and the lower airbag 2, and a soft edge connecting portion 4 disposed between any two of the adjacent upper airbags 1 and any two adjacent lower airbags 2, wherein the upper airbags 1, the lower airbags and the elastic material layer 3 are integrated into a one-piece structure.

Further, the upper airbag 1 and the lower airbag 2 are installed symmetrically with one another.

Further, the elastic material layer 3 is a TPU layer, and the TPU layer has a thickness of 0.3 mm.

Further, the width of the soft edge connecting portion 4 and the width of the upper airbag 1 and the lower airbag 2 are in the ratio of 1:5.

Further, the upper surface of the upper airbag 1 and the lower surface of the lower airbag 2 are substantially arc shaped.

The preparation method of the inflation-free double-sided airbag comprises the following two steps. Step (1) Unilateral Molding: Prepare a flat thermoplastic material. Heat the flat thermoplastic material to 120° C. and then press the flat thermoplastic material by a pressure of 10 kg/cm² to form separated grooves. Cool the flat thermoplastic material to room temperature to obtain a single-sided airbag material. (2) Sealing: Prepare two pieces of the molded single-sided airbag materials. Place the elastic material layer 3 between the two pieces of single-sided airbag materials. Heat the elastic material layer 3 to 180° C. and then press the elastic material layer and the two pieces of airbag materials by a pressure of 10 kg/cm², and naturally cool them to room temperature for formation. Further, the flat thermoplastic material is a flat material consisting of thermoplastic.

Wherein, the heating rate of heating the flat thermoplastic material to 120° C. as described in Step (1) is 5° C./min.

Wherein, the cooling rate as described in Step (1) is 35° C./min.

Wherein, the heating rate of heating the elastic material layer to 180° C. as described in Step (2) is 35° C./min.

### Embodiment 2

Embodiment 2 is substantially the same as Embodiment 1 except that the upper airbag 1 and the lower airbag 2 of Embodiment are staggered.

### Embodiment 3

Embodiment 3 is substantially the same as Embodiment 1 except that the elastic material layer 3 of Embodiment 3 is a TPU layer with a thickness of 0.5 mm.

### Embodiment 4

Embodiment 4 is substantially the same as Embodiment 1 except that the elastic material layer 3 of Embodiment 4 is a TPU layer with a thickness of 1.0 mm.

Embodiment 5

Embodiment 5 is substantially the same as Embodiment 1 except that the wide of the soft edge connecting portion 4 and the width of the upper airbag 1 and the lower airbag 2 of Embodiment 5 are in the ratio of 1:1.

### Embodiment 6

Embodiment 6 is substantially the same as Embodiment 1 except that the width of the soft edge connecting portion 4 and the width of the upper airbag 1 and the lower airbag 2 of Embodiment 6 are in the ratio of 1:3.

### Embodiment 7

Embodiment 7 is substantially the same as Embodiment 1 except that the preparation method of the inflation-free double-sided airbag of Embodiment & comprises the following two steps. Step (1) Unilateral Molding: Prepare a flat thermoplastic material. Heat the flat thermoplastic material to 180° C. and then press the flat thermoplastic material by a pressure of 15 kg/cm² to form separated grooves. Cool the flat thermoplastic material to room temperature to obtain a single-sided airbag material. (2) Sealing: Prepare two pieces of the molded single-sided airbag materials. Place the elastic material layer 3 between the two pieces of single-sided airbag materials. Heat the elastic material layer 3 to 180° C. and then press the elastic material layer and the two pieces of airbag materials by a pressure of 15 kg/cm², and naturally cool them to room temperature for formation. Further, the flat thermoplastic material is a flat material consisting of thermoplastic.

Wherein, the heating rate of heating the flat thermoplastic material to 180° C. as described in Step (1) is 8° C./min.

Wherein, the cooling rate as described in Step (1) is 35° C./min.

Wherein, the heating rate of heating the elastic material layer to 180° C. as described in Step (2) is 30° C./min.

### Embodiment 8

Embodiment 8 is substantially the same as Embodiment 1 except that the preparation method of the inflation-free double-sided airbag of Embodiment 8 comprises the following steps: Step (1) Unilateral Molding: Prepare a flat thermoplastic material. Heat the flat thermoplastic material to 150° C. and then press the flat thermoplastic material by a pressure of 10 kg/cm² to form separated grooves. Cool the flat thermoplastic material to room temperature to obtain a single-sided airbag material. (2) Sealing: Prepare two pieces of the molded single-sided airbag materials. Place the elastic material layer 3 between the two pieces of single-sided airbag materials. Heat the elastic material layer 3 to 180° C. and then press the elastic material layer and the two pieces of airbag materials by a pressure of 10 kg/cm², and naturally cool them to room temperature for formation. Further, the flat thermoplastic material is a flat material consisting of thermoplastic.

Wherein, the heating rate of heating the flat thermoplastic material to 180° C. as described in Step (1) is 15° C./min.

Wherein, the cooling rate as described in Step (1) is 35° C./min.

Wherein, the heating rate of heating the elastic material layer to 180° C. as described in Step (2) is 35° C./min.

While the invention has been described by means of specific embodiments, numerous modifications and variations could be made thereto by those skilled in the art without departing from the scope and spirit of the invention set forth in the claims.

What is claimed is:

1. An inflation-free double-sided airbag, comprising:
a plurality of upper airbags arranged into an array and coupled to one another to form a planar body;
a plurality of lower airbags arranged into an array and coupled to one another; and
an elastic material layer, disposed between the upper airbag and the lower airbag, and the upper surface of the elastic material layer being coupled to the upper airbag, and the lower surface of the elastic material layer being coupled to the lower airbag, and a soft edge connecting portion formed between two adjacent upper airbags and between two adjacent lower airbags.

2. The inflation-free double-sided airbag of claim 1, wherein the upper airbag and the lower airbag are installed symmetrically with respect to the elastic material layer.

3. The inflation-free double-sided airbag of claim 1, wherein the upper airbag and lower airbag are staggered with one another.

4. The inflation-free double-sided airbag of claim 1, wherein the elastic material layer is a TPU layer, a TPE layer, or a PVC layer.

5. The inflation-free double-sided airbag of claim 4, wherein the elastic material layer has a thickness of 0.3˜1.0 mm.

6. The inflation-free double-sided airbag of claim 1, wherein the width of the soft edge connecting portion and the width of the upper airbag are in a ratio of 1:1˜5; and the width of the soft edge connecting portion and the width of the lower airbag are in the ratio of 1:1˜5.

7. The preparation method of an inflation-free double-sided airbag according to claim 1, comprising: Step (1) Unilateral molding: preparing a flat thermoplastic material, heating the flat thermoplastic material to 120˜180° C. and then pressing the flat thermoplastic material by a pressure of 5kg/cm²˜10 kg/cm² to form a plurality of separated grooves, cooling the flat thermoplastic material to room temperature to obtain a single-sided airbag material; and Step (2) Sealing: taking two pieces of molded single-sided airbag material, and setting an elastic material layer between two pieces of single-sided airbag materials, and heating the elastic material layer to 120˜180° C. and then pressing the two pieces of molded single-sided airbag material and the elastic material layer altogether by a pressure of 10 kg/cm²˜20 kg/cm², and naturally cooling to room temperature for a formation.

8. The preparation method of an inflation-free double-sided airbag according to claim 2, comprising: Step (1) Unilateral molding: preparing a flat thermoplastic material, heating the flat thermoplastic material to 120˜180° C. and then pressing the flat thermoplastic material by a pressure of 5 kg/cm²˜10 kg/cm² to form a plurality of separated grooves, cooling the flat thermoplastic material to room temperature to obtain a single-sided airbag material; and Step (2) Sealing: taking two pieces of molded single-sided airbag material, and setting an elastic material layer between two pieces of single-sided airbag materials, and heating the elastic material layer to 120˜180° C. and then pressing the two pieces of molded single-sided airbag material and the elastic material layer altogether by a pressure of 10 kg/cm²˜20 kg/cm², and naturally cooling to room temperature for a formation.

9. The preparation method of an inflation-free double-sided airbag according to claim 3, comprising: Step (1) Unilateral molding: preparing a flat thermoplastic material, heating the flat thermoplastic material to 120˜180° C. and then pressing the flat thermoplastic material by a pressure of 5 kg/cm²˜10 kg/cm² to form a plurality of separated grooves, cooling the flat thermoplastic material to room temperature to obtain a single-sided airbag material; and Step (2) Sealing: taking two pieces of molded single-sided airbag material, and setting an elastic material layer between two pieces of single-sided airbag materials, and heating the elastic material layer to 120˜180° C. and then pressing the two pieces of molded single-sided airbag material and the elastic material layer altogether by a pressure of 10 kg/cm²˜20 kg/cm², and naturally cooling to room temperature for a formation.

10. The preparation method of an inflation-free double-sided airbag according to claim 4, comprising Step (1) Unilateral molding: preparing a flat thermoplastic material, heating the flat thermoplastic material to 120˜180° C. and then pressing the flat thermoplastic material by a pressure of 5 kg/cm²˜10 kg/cm² to form a plurality of separated grooves, cooling the flat thermoplastic material to room temperature to obtain a single-sided airbag material; and Step (2) Sealing: taking two pieces of molded single-sided airbag material, and setting an elastic material layer between two pieces of single-sided airbag materials, and heating the elastic material layer to 120˜180° C. and then pressing the two pieces of molded single-sided airbag material and the elastic material layer altogether by a pressure of 10 kg/cm²18 20 kg/cm², and naturally cooling to room temperature for a formation.

11. The preparation method of an inflation-free double-sided airbag according to claim 5, comprising Step (1) Unilateral molding: preparing a flat thermoplastic material, heating the flat thermoplastic material to 120˜180° C. and then pressing the flat thermoplastic material by a pressure of 5 kg/cm²˜10 kg/cm² to form a plurality of separated grooves, cooling the flat thermoplastic material to room temperature to obtain a single-sided airbag material; and Step (2) Sealing: taking two pieces of molded single-sided airbag material, and setting an elastic material layer between two pieces of single-sided airbag materials, and heating the elastic material layer to 120˜180° C. and then pressing the two pieces of molded single-sided airbag material and the elastic material layer altogether by a pressure of 10 kg/cm²˜20 kg/cm², and naturally cooling to room temperature for a formation.

12. The preparation method of an inflation-free double-sided airbag according to claim 6, wherein the flat thermoplastic material is heated to 120˜180° C. at a heating rate of 5˜15° C./min in Step (1).

13. The preparation method of an inflation-free double-sided airbag according to claim 6, wherein the cooling rate in Step (1) is 35˜50° C./min.

14. The preparation method of an inflation-free double-sided airbag according to claim 6, wherein the elastic material layer is heated to 120˜180° C. at a heating rate of 20˜35° C./min in Step (2).
